(19) United States
(12) Patent Application Publication
(10) Pub. No.: US 2003/0169446 A1
(43) Pub. Date: Sep. 11, 2003

(54) System and method for proxy management of a print job

(76) Inventors: Randall Edward Grohs, Star, ID (US); Melanie M. Robertson, Camas, WA (US); William Edward Hertling, Portland, OR (US)

Correspondence Address: HEWLETT-PACKARD COMPANY, Intellectual Property Administration, P.O. Box 272400, Fort Collins, CO, 80527-2400, US

(21) Appl. No.: 10/094,349

(22) Filed: Mar. 7, 2002

(51) Int. Cl. G06F 15/00; B41J 1/00

(52) U.S. Cl. 358/1.15

(57) ABSTRACT

A method of managing a print job of a user for a print provider includes registering the print provider with a print provider proxy, receiving the print job of the user at the print provider proxy for the print provider, and transferring the print job from the print provider proxy to the print provider when requested by the print provider.

### THE FIELD OF THE INVENTION

The present invention relates generally to print services, and more particularly to proxy management of a print job of a user for a print provider.

### BACKGROUND OF THE INVENTION

Customer service demands and changing technology often necessitate frequent upgrades to enable businesses such as print shops or print providers providing print services to perform more efficiently and handle larger work loads in an effort to address customer expectations of around-the-clock service and accessibility. These expectations require print shops to manage a large amount of print job information such as content files and/or job tickets for print jobs as well as print job estimates and print job status. Managing the large amount of print job information on, for example, a typical server or database located in a print shop, can be extremely time consuming and costly. Moreover, most print shops are often unable to allocate adequate resources to such systems for proper management and ensured reliability.

Presently, to meet customer service demands and keep up with changing technology, print shops need to expend a great deal of resources, including time, money, and labor. This requires that each print shop upgrade, maintain, and/or support large and expensive computer systems to ensure reliability and meet customer service demands on a 24 hours a day, seven days a week basis. To properly manage such systems requires print shops to conduct back-ups, store computerized data so that daily business operations can continue unimpeded, and prepare for data recovery in the event of a disaster resulting in lost files or print jobs because the print shop server was down or not dialed into a network. This kind of around-the-clock management is not only impractical, but often impossible for many print shops that simply do not have adequate resources. Moreover, not all users are sufficiently proficient with managing large computer systems to expeditiously accomplish this process. Improper management could result in hardware and software conflicts, failure to meet critical deadlines, loss of print job information, and, consequently, the loss of business.

Accordingly, a need exists for efficient and secure management of print jobs for print shops that meets customer demands and print shop needs for reliability and around-the-clock service and access.

### SUMMARY OF THE INVENTION

One aspect of the present invention provides a method of managing a print job of a user for a print provider. The method includes registering the print provider with a print provider proxy, receiving the print job of the user at the print provider proxy for the print provider, and transferring the print job from the print provider proxy to the print provider when requested by the print provider.

### BRIEF DESCRIPTION OF THE DRAWINGS

FIG. 1 is a block diagram illustrating one exemplary embodiment of a print job proxy management system according to the present invention.

FIG. 2 is a block diagram illustrating one exemplary embodiment of information flow through the print job proxy management system of FIG. 1.

FIG. 3 is a block diagram illustrating one exemplary embodiment of the print job proxy management system of FIG. 1 supporting multiple print providers.

FIG. 4 is a block diagram illustrating one exemplary embodiment of the print job proxy management system of FIG. 1 supporting multiple document management applications.

FIGS. 5A and 5B are a block diagram illustrating one exemplary embodiment of registration with the print job proxy management system of FIG. 1.

### DESCRIPTION OF THE PREFERRED EMBODIMENTS

In the following detailed description of the preferred embodiments, reference is made to the accompanying drawings, which form a part hereof, and in which is shown by way of illustration, specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

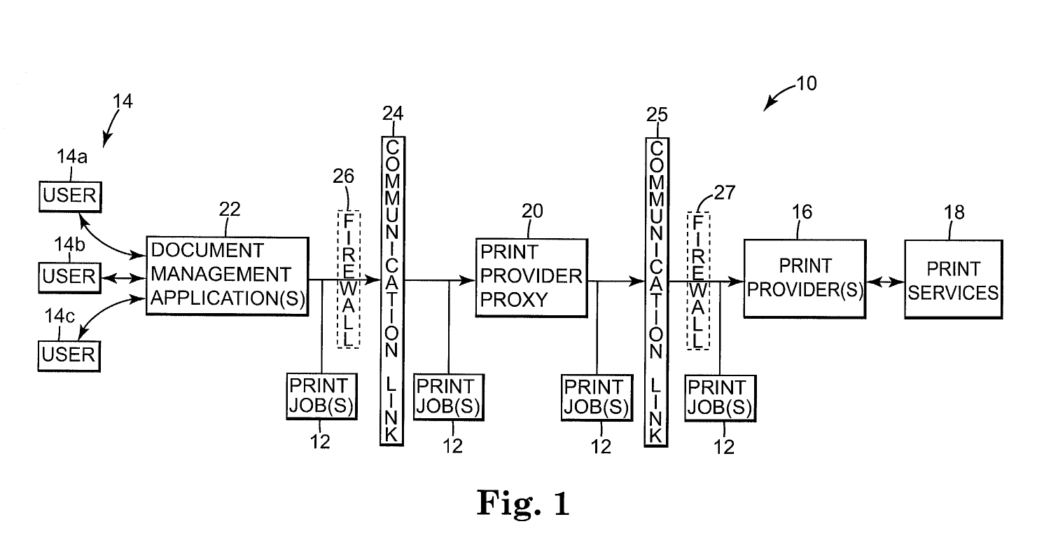

A print job proxy management system according to the present invention is illustrated generally at 10 in FIG. 1. Print job proxy management system 10 provides proxy services to a print job 12 of a user 14 for a print provider 16 offering print services 18. More specifically, print job proxy management system 10 provides a centralized system for receipt of print job 12 and transfer of print job 12 to print provider 16 when requested by print provider 16. In one exemplary embodiment, print job proxy management system 10 enables print provider 16 to receive print job 12 of user 14 without direct interaction with print provider 16. As such, print job proxy management system 10 enables user 14 to request print services 18 of print provider 16 by sending print job 12 to print provider 16 even though print provider 16 is unavailable to receive print job 12.

Print job 12, as used herein, is defined to include a piece of work requiring production and/or reproduction of printed matter. Print job 12 may be a digital or electronic print job and include one or more print jobs or subsets of print jobs to be processed by print job proxy management system 10. User 14, as used herein, is defined to include an entity or entities such as a customer, a consumer, an employee, or another print provider requesting or soliciting printing services, finishing services, delivery services, and/or other print processing services. User 14, therefore, includes any user of such printing, finishing, delivery, and/or other print processing services.

Print provider 16, as used herein, is defined to include an entity or entities offering, providing, and/or assisting in printing services, finishing services, delivery services, and/or other print processing services. Print provider 16 may be one or more of such print providers. Print services 18, as used herein, is defined to include printing services, finishing services, delivery services, and/or other print processing services.

In one exemplary embodiment, print job proxy management system 10 includes a print provider proxy 20 which manages and/or coordinates processing of print job 12 for print provider 16. More specifically, print provider proxy 20 receives print job 12 and transfers print job 12 to print provider 16 when requested by print provider 16, as described below. In addition, print job proxy 20 provides centralized management of print processing services for print job 12 and/or print provider 16, including a status of processing of print job 12 by print provider 16, as described below. As such, print job proxy management system 10 facilitates processing of print job 12 for print provider 16.

Print provider proxy 20 includes hardware, software, firmware, or a combination of these. In one exemplary embodiment, print provider proxy 20 includes a computer server or other microprocessor based system capable of performing a sequence of logic operations. In addition, print provider proxy 20 can include a microprocessor embedded system/appliance incorporating tailored appliance hardware and/or dedicated single purpose hardware.

In one exemplary embodiment, user 14 interacts with a job creation or document management application 22 to define print job 12 and, more specifically, specify a document for print job 12 and/or identify attributes of print job 12, as described below. As such, print provider proxy 20 receives print job 12 from document management application 22. In one exemplary embodiment, multiple users 14a, 14b, 14c interact with document management application 22 to define respective print jobs 12. In addition, multiple document management applications 22 each facilitating specification of a respective print job 12 and/or multiple print providers 16 each providing respective print services 18 may be supported by print job proxy management system 10, as described below.

In one exemplary embodiment, document management application 22 and print provider proxy 20 communicate with each other via a communication link 24 and print provider proxy 20 and print provider 16 communicate with each other via a communication link 25. Communication links 24 and 25, as used herein, are each defined to include a network communication link such as a local-area network (LAN) link and/or a wide-area network (WAN) link. Communication links 24 and 25, therefore, may each include a high speed communication link such as an intranet communication link or an Internet communication link. In addition, communication links 24 and 25 may each include a wireless communication link. While communication links 24 and 25 are illustrated as separate communication links, it is within the scope of the present invention for communication links 24 and 25 to be the same communication link.

In one exemplary embodiment, user 14 and document management application 22, print provider proxy 20, and print provider 16 are located remote from each other. Thus, communications between document management application 22 and print provider proxy 20 are conducted over communication link 24, and communications between print provider proxy 20 and print provider 16 are conducted over communication link 25. It is, however, within the scope of the present invention for user 14 and document management application 22, print provider proxy 20, and/or print provider 16 to be located at the same location. Thus, document management application 22, print provider proxy 20, and/or print provider 16 may communicate in other manners (e.g., a direct or wireless connection).

In one exemplary embodiment, a firewall 26 is interposed between document management application 22 and print provider proxy 20 and a firewall 27 is interposed between print provider proxy 20 and print provider 16. As such, firewall 26 protects document management application from other users of communication link 24 and firewall 27 protects print provider 16 from other users of communication link 25. Thus, firewalls 26 and 27 limit outside access to document management application 22 and print provider 16, respectively.

Components of print job proxy management system 10, including print provider proxy 20, can be implemented in hardware via a microprocessor, programmable logic device, or state machine, in firmware, or in software within a given device. In one embodiment, at least a portion of software programming for print job proxy management system 10 is written in JAVA programming language and each of the main components communicates via communication links 24 and 25 using a communication bus protocol. For example, the present invention may or may not use a TCP/IP protocol suite for data transport. Other programming languages and communication bus protocols suitable for use with the present invention will become apparent to those skilled in the art after reading the present application.

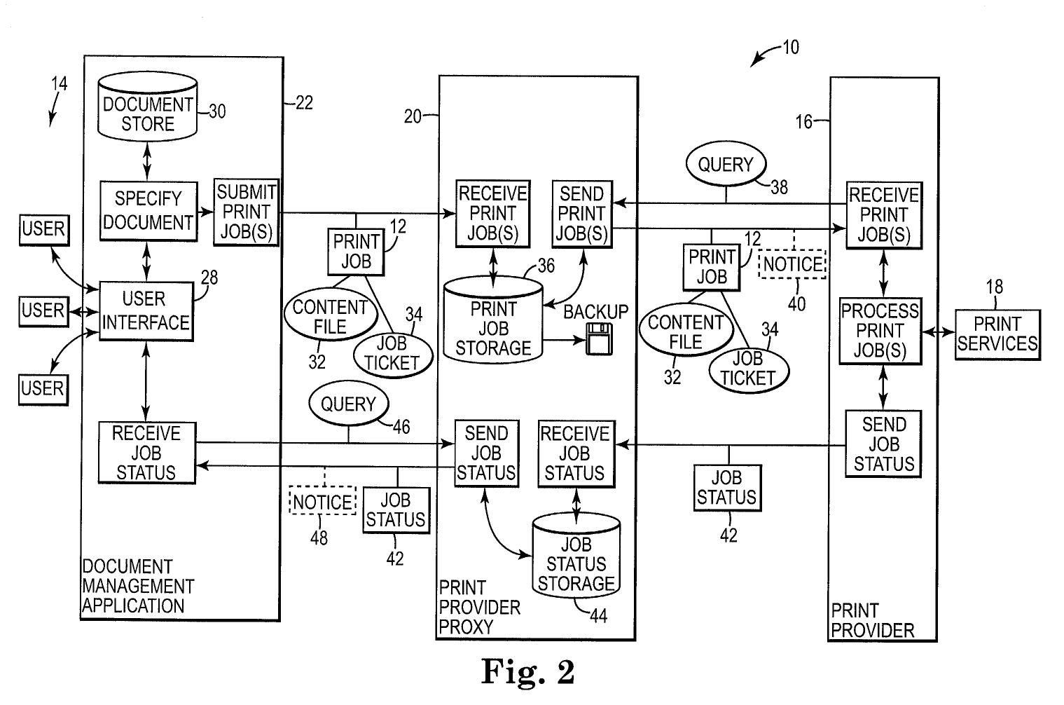

As illustrated in FIG. 2, one or more users 14 interact with document management application 22 to submit print job 12 to print provider proxy 20 and, ultimately, print provider 16. It is understood that print provider proxy 20 may provide a “store front” to print provider 16. Thus, print job proxy management system 10 may be implemented such that user 14 knows that they are sending print job 12 to print provider proxy 20 or that user 14 thinks that they are sending print job 12 directly to print provider 16 even though they are actually sending print job 12 to print provider proxy 20.

Preferably, document management application 22 includes a user interface 28 with which user 14 interacts to specify a document for print job 12. In one exemplary embodiment, user 14 accesses user interface 28 of document management application 22 via a computer (not shown). Such a computer includes, for example, an input device such as a keyboard and/or a mouse, and a display device such as a monitor, as is well known in the art. In addition, the computer may be an appliance such as a personal digital assistant (PDA), cellular phone, etc.

In one exemplary embodiment, document management application 22 includes a database 30 which forms a document store of documents available for printing by print provider 16. More specifically, print provider 16 stores prepared documents, including document templates, for user 14 at database 30. Examples of database 30 include non-volatile memory (e.g., a hard disk drive or other persistent storage device) and may include volatile memory (e.g., random access memory (RAM)).

In one exemplary embodiment, user 14 interacts with user interface 28 to order a document for print job 12 by searching database 30 and selecting a document for print job 12 from the document store. In another exemplary embodiment, user interacts with user interface 28 of document management application 22 to create and/or select a document for print job 12. As such, a content file 32, such as a portable document format (PDF) or other document format, representing data of the document for print job 12 is associated with print job 12.

In one exemplary embodiment, user 14 also interacts with user interface 28 of document management application 22 to select and/or specify attributes of print job 12 such as a file format, a print medium size, a print medium type, a number of copies, a printing quality option, a printing layout, a color printing option, a finishing option, and/or a delivery option for print job 12. In one exemplary embodiment, attributes of print job 12 are identified with a job ticket 34 for print job 12. Thus, job ticket 34 includes, for example, an XML document describing the intent of the finished product. As such, job ticket 34 is also associated with print job 12.

With content file 32 and job ticket 34 identified for print job 12, user 14 posts or submits print job 12 to print provider proxy 20 via document management application 22. As such, document management application 22 initiates communication with print provider proxy 20 and pushes print job 12 to print provider proxy 20. In one exemplary embodiment, document management application 22 submits print job 12 to print provider proxy 20 via firewall 26 and communication link 24 (FIG. 1). Thus, security of document management application 22 is maintained.

When print provider proxy 20 receives print job 12, including content file 32 and job ticket 34 for print job 12, print provider proxy 20 stores print job 12 in a database 36 providing print job storage. Examples of database 36 include non-volatile memory (e.g., a hard disk drive or other persistent storage device) and may include volatile memory (e.g., random access memory (RAM)). In addition, in one exemplary embodiment, print provider proxy 20 maintains a backup of print job 12 as stored in database 36. As such, print provider proxy 20 provides for receipt and storage of print job 12 for print provider 16.

Until requested by print provider 16, print provider proxy 20 tracks and stores print job 12. However, when requested by print provider 16, print provider proxy 20 transfers print job 12, including content file 32 and job ticket 34 for print job 12, to print provider 16. Preferably, print provider 16 contacts print provider proxy 20 to transfer print job 12. As such, print provider 16 initiates communications with print provider proxy 20 and pulls print job 12 from print provider proxy 20.

In one exemplary embodiment, print provider 16 submits a query 38 to print provider proxy 20 requesting print job 12 as submitted for print provider 16. Thus, in response to query 38, print provider proxy 20 searches database 36 and retrieves print job 12, including content file 32 and job ticket 34 for print job 12, for print provider 16. Accordingly, print provider proxy 20 sends print job 12, including content file 32 and job ticket 34 for print job 12, to print provider 16. In one exemplary embodiment, print provider 16 sends query 38 and print provider proxy 20 sends print job 12, including content file 32 and job ticket 34 for print job 12, to print provider 16 via communication link 25 and firewall 27 (FIG. 1). Thus, security of print provider 16 is maintained.

In one exemplary embodiment, print provider proxy 20 notifies print provider 16 that print job 12 has been received for print provider 16. For example, print provider proxy 20 sends a notice 40 to print provider 16 informing print provider 16 of print job 12. In one exemplary embodiment, print provider proxy 20 sends notice 40 in the form of an electronic mail (e-mail) message to print provider 16 via communication link 25 and firewall 27.

Once print provider 16 receives print job 12, including content file 32 and job ticket 34 for print job 12, print provider 16 processes print job 12 with print services 18. Processing of print job 12 includes, for example, printing, finishing, and/or delivery of print job 12 for user 14. With print provider proxy 20 receiving, storing, and transferring print job 12 for print provider 16, and print provider 16 processing and completing print job 12 with print services 18, print provider proxy 20 and print provider 16 constitute a fulfillment system for print job 12.

In one exemplary embodiment, print provider 16 monitors a job status 42 of print job 12 during processing. As such, print provider 16 sends job status 42 to print provider proxy 20 for user 14. In one exemplary embodiment, print provider 16 sends job status 42 to print provider proxy 20 via communication link 25 and firewall 27 (FIG. 1).

When print provider proxy 20 receives job status 42 of print job 12, print provider proxy 20 stores job status 42 in a database 44 providing job status storage. Examples of database 44 include non-volatile memory (e.g., a hard disk drive or other persistent storage device) and may include volatile memory (e.g., random access memory (RAM)). As such, print provider proxy 20 provides for receipt and storage of job status 42 of print job 12.

In one exemplary embodiment, user 14 interacts with document management application 22 via user interface 28 to check job status 42 of print job 12. More specifically, user 14, via document management application 22, contacts print provider proxy 20 to request job status 42 of print job 12. As such, document management application 22 initiates communications with print provider proxy 20 and pulls job status 42 from print provider proxy 20.

In one exemplary embodiment, document management application 22 submits a query 46 to print provider proxy 20 requesting job status 42 of print job 12. Thus, in response to query 46, print provider proxy 20 searches database 44 and retrieves job status 42 of print job 12 for user 14. Accordingly, print provider proxy 20 sends job status 42 to document management application 22. In one exemplary embodiment, document management application 22 sends query 46 to print provider proxy 20 and print provider proxy 20 sends job status 42 to document management application 22 via communication link 24 and firewall 26 (FIG. 1). Thus, security of document management application 22 is maintained.

In one exemplary embodiment, print provider proxy 20 notifies user 14 and, more specifically, document management application 22 that job status 42 for print job 12 has been received from print provider 16. For example, print provider proxy 20 sends a notice 48 to document management application 22 informing user 14 of job status 42 of print job 12. In one exemplary embodiment, print provider proxy 20 sends notice 48 in the form of an electronic mail (e-mail) message to document management application 22 via communication link 24 and firewall 26 (FIG. 1).

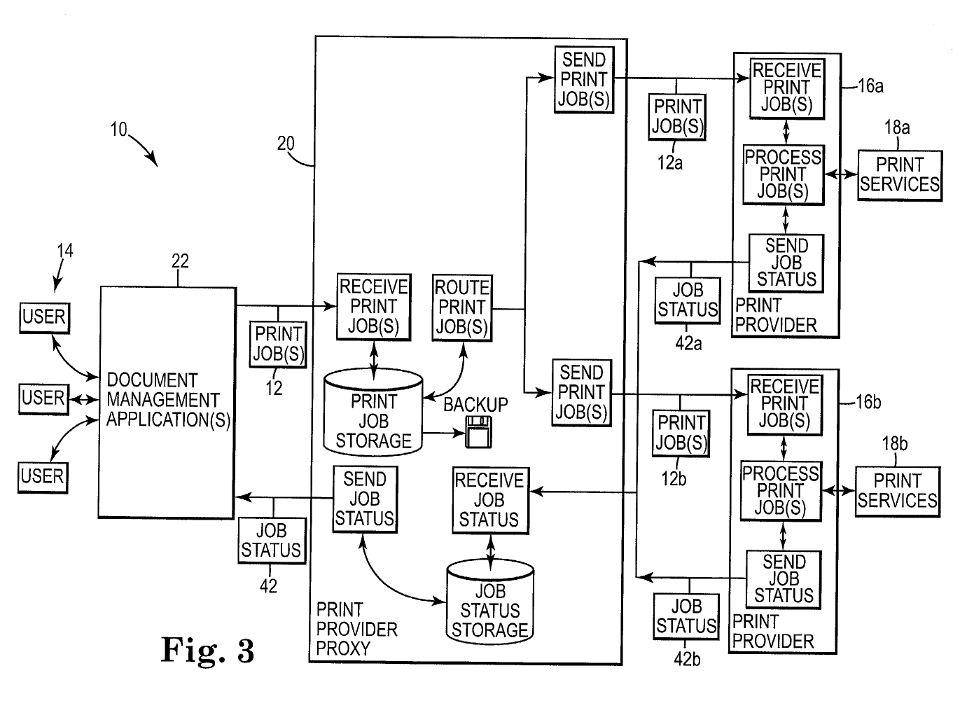

In one exemplary embodiment, as illustrated in FIG. 3, print provider proxy 20 provides proxy services for multiple print providers 16. For example, print provider proxy 20 provides proxy services for a print provider 16a offering print services 18a and a print provider 16b offering print services 18b. As such, print provider proxy 20 receives print job 12 for print provider 16a and/or print provider 16b and routes print job 12 to print provider 16a and/or print provider 16b. More specifically, print provider proxy 20 routes a print job 12a to print provider 16a and a print job 12b to print provider 16b. In addition, print provider proxy 20 receives and processes a job status 42a of print job 12a from print provider 16a and a job status 42b of print job 12b from print provider 16b.

In one exemplary embodiment, print provider proxy 20 routes print job 12 to print provider 16a and/or print provider 16b based on a capability and/or an availability of print provider 16a and/or print provider 16b to complete print job 12 and/or a geographic location of user 14 and/or print provider 16a and/or print provider 16b. Although not illustrated in FIG. 3, it is understood that print provider proxy 20 and print provider 16a and/or print provider 16b communicate via communication link 25 and that firewall 27 may be interposed between print provider proxy 20 and print provider 16a and/or print provider 16b.

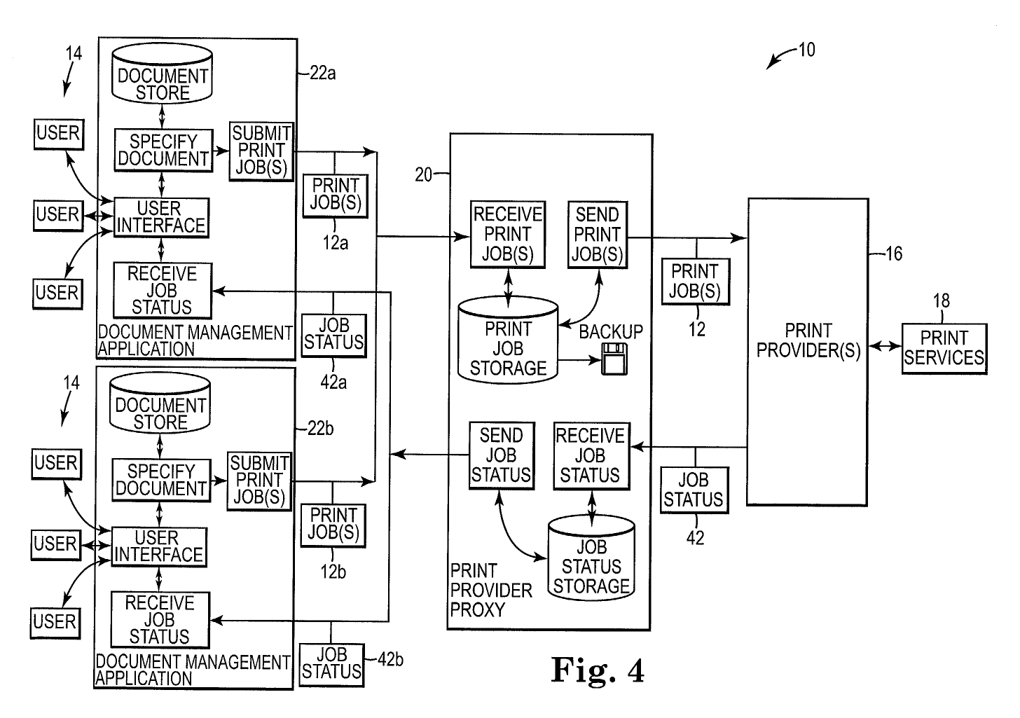

In one exemplary embodiment, as illustrated in FIG. 4, print provider proxy 20 supports multiple document management applications 22. For example, print provider proxy 20 supports a document management application 22a and a document management application 22b. As such, print provider proxy 20 receives a print job 12a from document management application 22a and a print job 12b from document management application 22b. Thus, print provider proxy 20 provides for receipt and storage of print job 12a, as submitted from document management application 22a, and print job 12b, as submitted from document management application 22b, for print provider 16 until requested by print provider 16. In addition, print provider proxy 20 processes and sends a job status 42a of print job 12a to document management application 22a and a job status 42b of print job 12b to document management application 22b. Although not illustrated in FIG. 4, it is understood that print provider proxy 20 and document management application 22a and/or document management application 22b communicate via communication link 24 and that firewall 26 may be interposed between print provider proxy 20 and/or document management application 22a and/or document management application 22b.

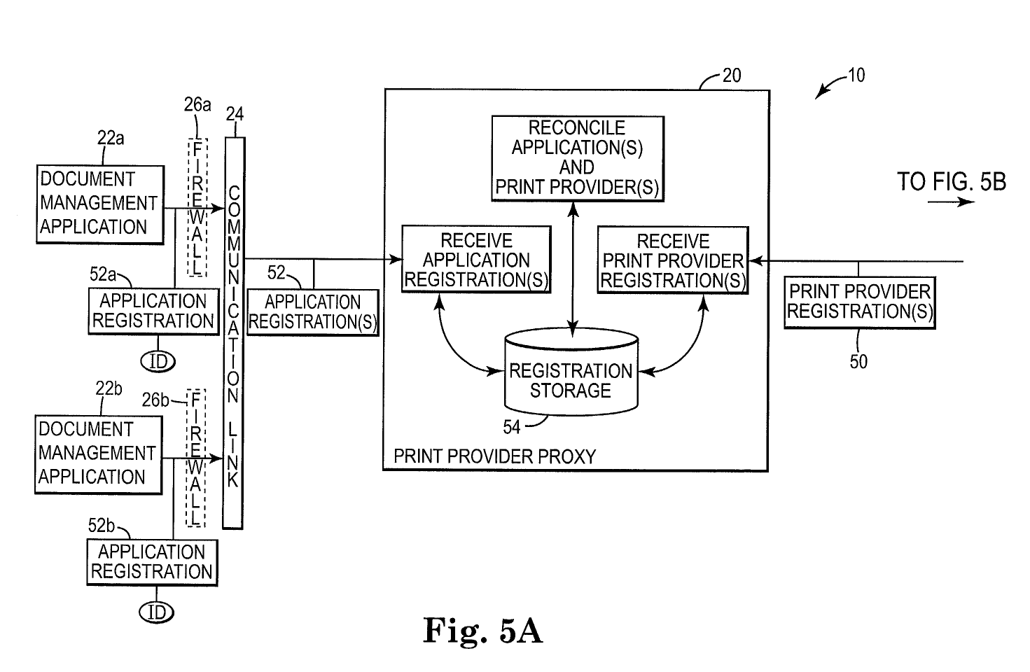

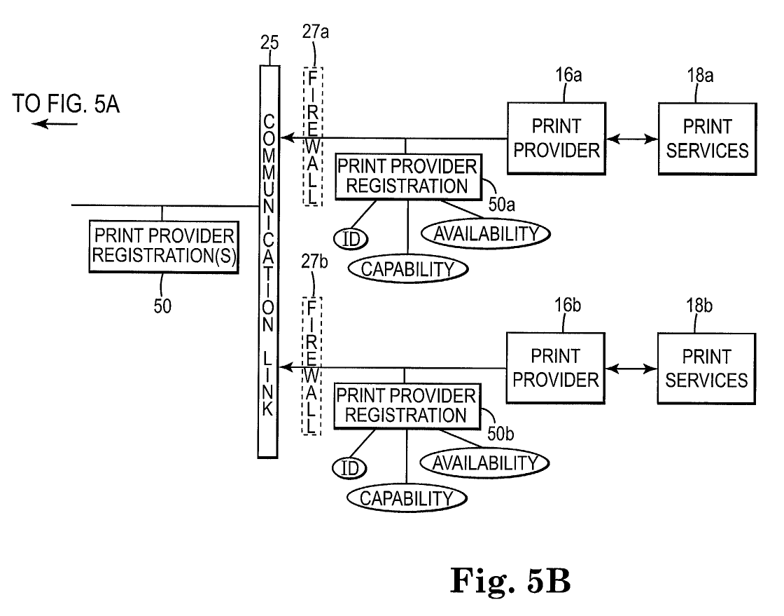

In one exemplary embodiment, as illustrated in FIGS. 5A and 5B, one or more print providers 16 and one or more document management applications 22 can register with print provider proxy 20. As such, print providers 16a and 16b submit print provider registrations 50a and 50b, respectively, and document management applications 22a and 22b submit application registrations 52a and 52b, respectively, to print provider proxy 20. In one exemplary embodiment, print providers 16a and 16b submit respective print provider registrations 50a and 50b to print provider proxy 20 via communication link 25 and respective firewalls 27a and 27b and document management applications 22a and 22b submit respective application registrations 52a and 52b to print provider proxy 20 via communication link 24 and respective firewalls 26 and 27.

Print provider registration 50 of print provider 16 provides information about print provider 16 such as identification of print provider 16, including security information of print provider 16, capability of print provider 16 to process print job 12, including software versions of print provider 16, and/or availability of print provider 16 to process print job 12. Application registration 52 of document management application 22 provides information about document management application 22 such as identification of document management application 22, including security information of document management application 22. When print provider proxy 20 receives print provider registration 50 and application registration 52, print provider proxy 20 stores print provider registration 50 and application registration 52 in a database 54 providing registration storage. Examples of database 54 include non-volatile memory (e.g., a hard disk drive or other persistent storage device) and may include volatile memory (e.g., random access memory (RAM)).

To manage print job proxy management system 10, print provider proxy 20 reconciles document management applications 22 and print providers 16. More specifically, print provider proxy 20 reconciles document management applications 22 and print providers 16 by, for example, authenticating security information of document management applications 22 and print providers 16, and/or comparing print jobs 12 submitted by document management applications 22 with capability and/or availability of print providers 16 to process print jobs 12. As such, print providers 16 and document management applications 22 each represent clients of print provider proxy 20.

With print provider proxy 20, additional print providers 16, possibly providing additional print processing capabilities, can be added to print job proxy management system 10, without direct interaction and/or coordination with document management application 22. In addition, print providers 16 wishing to connect to more than one document management application 22, can do so by simply connecting to a single proxy such as print provider proxy 20.

With print job proxy management system 10, a primary interface between document management application 22 and print provider proxy 20 is developed. More specifically, print job proxy management system 10 provides a programmatic “Business-to-Business” interface between document management application 22 and print provider proxy 20 including a secure mechanism for programmatically submitting or posting print job 12 to print provider proxy 20, information for print job 12, such as content file 32 and job ticket 34, as well as a secure mechanism for programmatically requesting job status 42 of print job 12.

By being centrally deployed and highly available, print provider proxy 20 enables print provider 16 to receive print job 12 without direct interaction with document management application 22 and/or user 14. Thus, by providing proxy services for print provider 16, print provider proxy 20 enables print provider 16 to receive print job 12 even though print provider 16 is unavailable. In addition, when print provider 16 is behind firewall 27 and document management application 22 is behind firewall 26, print provider proxy 20 serves as a central communication mechanism that allows print provider 16 and document management application 22 to communicate securely with each other by providing a “bridge” between them. Furthermore, by supporting print job storage, print provider proxy 20 provides back-up storage for print job 12, even though print provider 16 has downloaded loaded print job 12 for processing.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A method of managing a print job of a user for a print provider, the method comprising:
registering the print provider with a print provider proxy;
receiving the print job of the user at the print provider proxy for the print provider; and
transferring the print job from the print provider proxy to the print provider when requested by the print provider.

2. The method of claim 1, further comprising:
interposing a firewall between the print provider and the print provider proxy,
wherein transferring the print job from the print provider proxy to the print provider includes transferring the print job from the print provider proxy to the print provider through the firewall.

3. The method of claim 1, further comprising:
interposing a firewall between the user and the print provider proxy,
wherein receiving the print job at the print provider proxy includes receiving the print job at the print provider proxy through the firewall.

4. The method of claim 1, wherein receiving the print job at the print provider proxy includes receiving at least one of a content file and a job ticket for the print job at the print provider proxy, and wherein transferring the print job from the print provider proxy to the print provider includes transferring the at least one of the content file and the job ticket for the print job to the print provider.

5. The method of claim 1, further comprising:
at least one of storing the print job of the user for the print provider at the print provider proxy and maintaining a backup of the print job for the print provider at the print provider proxy.

6. The method of claim 1, further comprising:
sending a notice of the print job to the print provider after receiving the print job at the print provider proxy.

7. The method of claim 1, wherein transferring the print job from the print provider proxy to the print provider includes receiving a query for the print job from the print provider at the print provider proxy and sending the print job from the print provider proxy to the print provider in response to the query.

8. The method of claim 1, wherein transferring the print job from the print provider proxy to the print provider includes pulling the print job from the print provider proxy.

9. The method of claim 1, further comprising:
processing a status of the print job for the user at the print provider proxy.

10. The method of claim 1, wherein registering the print provider with the print provider proxy includes registering at least one of an identification, a capability, and an availability of the print provider with the print provider proxy.

11. The method of claim 1, wherein receiving the print job at the print provider proxy includes receiving the print job from an application, and further comprising:
reconciling the application and the print provider at the print provider proxy, including establishing a secure connection between the application and the print provider.

12. A system for managing a print job of a user for a print provider, the system comprising:
a print provider proxy configured to have the print provider registered therewith,
wherein the print provider proxy is adapted to receive the print job of the user from the user for the print provider and transfer the print job to the print provider when requested by the print provider.

13. The system of claim 12, wherein the print provider proxy is adapted to receive at least one of a content file and a job ticket for the print job and transfer the at least one of the content file and the job ticket for the print job to the print provider when requested by the print provider.

14. The system of claim 12, wherein the print provider proxy is adapted to at least one of store the print job of the user for the print provider and maintain a backup of the print job for the print provider.

15. The system of claim 12, wherein the print provider proxy is adapted to send a notice of the print job to the print provider when the print job is received from the user.

16. The system of claim 12, wherein the print provider proxy is adapted to receive a query for the print job from the print provider and send the print job to the print provider in response to the query.

17. The system of claim 12, wherein the print provider proxy is adapted to process a status of the print job for the user.

18. The system of claim 12, wherein the print provider proxy is configured to have at least one of an identification, a capability, and an availability of the print provider registered therewith.

19. The system of claim 12, wherein the print provider proxy is adapted to receive the print job from an application and establish a secure connection between the application and the print provider to reconcile the application and the print provider.

20. The system of claim 12, further comprising:
a firewall interposed between the print provider and the print provider proxy,
wherein the print provider proxy is adapted to transfer the print job to the print provider through the firewall.

21. The system of claim 12, further comprising:
a firewall interposed between the user and the print provider proxy,
wherein the print provider proxy is adapted to receive the print job of the user from the user through the firewall.

22. A computer-readable medium having computer-executable instructions for performing a method of managing a print job of a user for a print provider, the method comprising:
registering the print provider with a print provider proxy;
receiving the print job of the user at the print provider proxy for the print provider; and
transferring the print job from the print provider proxy to the print provider when requested by the print provider.

23. The computer-readable medium of claim 22, the method further comprising:
interposing a firewall between the print provider and the print provider proxy,
wherein transferring the print job from the print provider proxy to the print provider includes transferring the print job from the print provider proxy to the print provider through the firewall.

24. The computer-readable medium of claim 22, the method further comprising:
interposing a firewall between the user and the print provider proxy,
wherein receiving the print job at the print provider proxy includes receiving the print job at the print provider proxy through the firewall.

25. The computer-readable medium of claim 22, wherein receiving the print job at the print provider proxy includes receiving at least one of a content file and a job ticket for the print job at the print provider proxy, and wherein transferring the print job from the print provider proxy to the print provider includes transferring the at least one of the content file and the job ticket for the print job to the print provider.

26. The computer-readable medium of claim 22, the method further comprising:
at least one of storing the print job of the user for the print provider at the print provider proxy and maintaining a backup of the print job for the print provider at the print provider proxy.

27. The computer-readable medium of claim 22, the method further comprising:
sending a not ice of the print job to the print provider after receiving the print job at the print provider proxy.

28. The computer-readable medium of claim 22, wherein transferring the print job from the print provider proxy to the print provider includes receiving a query for the print job from the print provider at the print provider proxy and sending the print job from the print provider proxy to the print provider in response to the query.

29. The computer-readable medium of claim 22, wherein transferring the print job from the print provider proxy to the print provider includes pulling the print job from the print provider proxy.

30. The computer-readable medium of claim 22, the method further comprising:
processing a status of the print job for the user at the print provider proxy.

31. The computer-readable medium of claim 22, wherein registering the print provider with the print provider proxy includes registering at least one of an identification, a capability, and an availability of the print provider with the print provider proxy.

32. The computer-readable medium of claim 22, wherein receiving the print job at the print provider proxy includes receiving the print job from an application, and the method further comprising:
reconciling the application and the print provider at the print provider proxy, including establishing a secure connection between the application and the print provider.

33. A method of managing a print job of a user for a print provider, the method comprising:
registering the print provider with a print provider proxy;
receiving the print job of the user at the print provider proxy for the print provider;
sending a notice of the print job to the print provider; and
transferring the print job from the print provider proxy to the print provider when requested by the print provider, including receiving a query for the print job from the print provider at the print provider proxy and sending the print job from the print provider proxy to the print provider in response to the query.

34. The method of claim 33, further comprising:
storing the print job of the user for the print provider at the print provider proxy and maintaining a backup of the print job for the print provider at the print provider proxy.

35. The method of claim 33, wherein transferring the print job from the print provider proxy to the print provider includes pulling the print job from the print provider proxy.

36. A system for managing a print job of a user for a print provider, the system comprising:
a print provider proxy configured to have the print provider registered therewith,
wherein the print provider proxy is adapted to receive the print job of the user from the user for the print provider, send a notice of the print job to the print provider when the print job is received from the user, receive a query for the print job from the print provider, and send the print job to the print provider in response to the query.

37. The system of claim 36, wherein the print provider proxy is adapted to store the print job of the user for the print provider and maintain a backup of the print job for the print provider.

38. A computer-readable medium having computer-executable instructions for performing a method of managing a print job of a user for a print provider, the method comprising:
registering the print provider with a print provider proxy;
receiving the print job of the user at the print provider proxy for the print provider;
sending a notice of the print job to the print provider; and
transferring the print job from the print provider proxy to the print provider when requested by the print provider, including receiving a query for the print job from the print provider at the print provider proxy and sending the print job from the print provider proxy to the print provider in response to the query.
